(19) United States
(12) Patent Application Publication
(10) Pub. No.: US 2002/0113777 A1
(43) Pub. Date: Aug. 22, 2002

(54) Exit key for computer keyboard

(76) Inventor: John Lauderdale, Gillette, NJ (US)

Correspondence Address: Ernest D. Buff, Esq., Ernest D. Buff & Associates, LLC, 245 South Street, Morristown, NJ, 07960, US

(21) Appl. No.: 09/789,469

(22) Filed: Feb. 21, 2001

(51) Int. Cl. G09G 5/00

(52) U.S. Cl. 345/168

(57) ABSTRACT

A computer having an operating system and open applications and documents is shut down automatically, without further input from a user. The computer has an emergency exit key, which is depressed for a preselected period of time to activate shut down. A document list is stored in the memory of the computer for listing preselected documents. A shutdown manager saves any open documents that constitute a member of the document list. The shutdown manager also terminates open applications, and dismisses dialogs generated by applications or the operating system. An application list containing preselected applications and a back-up list containing preselected files are, optionally, stored in the memory of the computer. The shutdown manager saves open files created by applications that constitute a member of the application list, and backs-up files constituting a member of the back-up list. Shutdown protocol is preselected by the computer operator. After activation of the emergency shutdown key, no further input or action from the user is required. A rapid and controlled shutdown of the computer is accomplished without damage to its operating system or file directories.

### BACKGROUND OF THE INVENTION

1. Field of the Invention

The present invention relates to an information processing apparatus, such as a personal computer; and more particularly, to an emergency exit key that triggers software operative to save all open documents, shut down all applications, and shut off the computer without further input, upon being pressed for a preselected period of time.

2. Description of the Prior Art

Various systems for shutting down computers have been disclosed by prior art workers. Many of these systems, including those disclosed by U.S. Pat. Nos. 5,751,950 and 6,105,140 to Crisan, and U.S. Pat. No. 5,915,118 to Migita, are concerned with emergency power to accommodate inadvertent loss of power.

Other systems, disclosed by U.S. Pat. No. 5,848,280 to Hanaoka, are concerned with preserving the programs running on a computer and returning those programs to the point when the power supply was last turned off. Numerous back-up programs have been configured to automatically back-up data when shutting down a computer. However, there exists no method or means to shut down a computer without first taking care of any open documents.

Presently, when shutting down a personal computer, one has three choices: (a) saving open documents, closing all open applications, and then selecting shutdown; (b) selecting shutdown and then answering a series of dialogs concerning any open documents; and (c) turning off the power. Options (a) and (b) are time consuming, and frequently delay the user. Option (c) triggers directory scanning subsequent start up of the computer, and oftentimes leads to loss of important files.

There remains a need in the art for a system and method that automatically saves important documents, which are open on a computer, and shuts down the computer without further input form the user.

### SUMMARY OF THE INVENTION

The present invention provides a method and means for shutting down a computer in an efficient, reliable manner. Upon being triggered, the method and means of the invention operate automatically to save important documents, terminate all applications, dismiss all dialogs, and shut down the computer without further input for the user.

In one embodiment, the invention provides a computer, operative to shut down all applications and save preselected documents without further input from a user. The computer comprises an emergency exit key, a document list stored in the memory of the computer, for listing the preselected documents, and a shutdown manager for saving any open documents that constitute a member of the document list. The shutdown manager also, terminates open applications, and dismisses dialogs generated by applications or the operating system. Optionally, the computer further comprises an application list that lists preselected applications stored in the memory of the computer. The shutdown manager is operative to save, upon shutdown, any open documents created with applications that constitute a member of the application list. As a further option, the computer comprises a back-up list that lists preselected files stored in the memory of the computer. The shutdown manager is operative to back up, upon shutdown, any files that constitute a member of the back-up list.

In another embodiment, the invention provides a method for shutting down a computer. The method is initiated when a user pushes a preselected key or combination of keys for a preselected time and continues without further input from the user, until the computer is shut down. Generally stated, the method comprises (a) saving any open preselected document to a preselected storage location; (b) terminating all open documents; (c) terminating all open applications; (d) dismissing all dialog windows; and (e) powering down the computer. Optionally, in accordance with the method, the step of backing-up preselected files to a preselected storage location, is carried out prior to powering down. As a further option, the step of closing any open document associated with an application that is a member of a preselected application list occurs prior to closing of all open documents.

Advantageously, the method and means of this invention allows the user to preselect the manner in which the computer will be shut down. Shutdown is thereafter readily accomplished by activation of the emergency shutdown key. No further inputs or action from the user is required. A rapid and controlled shutdown of the computer is accomplished without damage to its operating system or file directories.

### BRIEF DESCRIPTION OF DRAWINGS

The invention will be more fully understood and further advantages will become apparent when reference is had to the following detailed description and the accompanying drawings, in which:

FIG. 1 is a schematic diagram depicting the system of the present invention;

FIG. 2 is a block flow diagram depicting the method steps employed to preselect preferences for the system depicted by FIG. 1;

FIG. 3 is a diagrammatic view showing a sample setup window for saving documents;

FIG. 4 is a diagrammatic view showing a sample set-up window for backing-up files;

FIG. 5 is a schematic diagram depicting a fast shutdown system;

FIG. 6 is a block flow diagram depicting the method steps employed to practice this invention; and

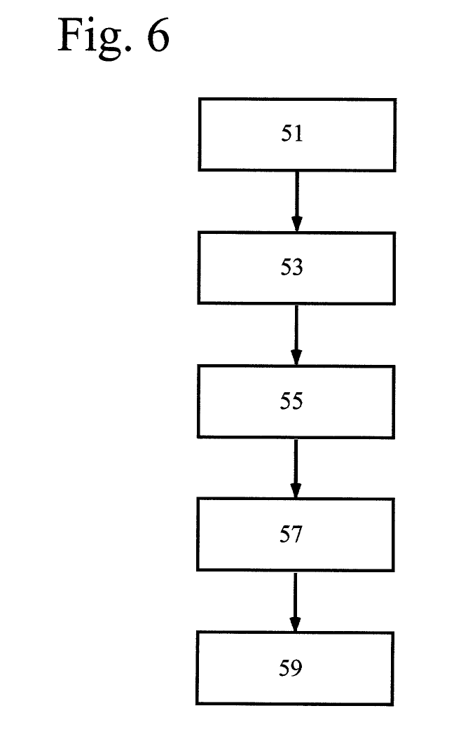

FIG. 7 is a block flow diagram depicting the method steps carried out in FIG. 6 with optional steps.

### DESCRIPTION OF THE PREFERRED EMBODIMENTS

Software utilized by computers generally falls into three types: operating systems, such as Macintosh OS 8.6 or Windows 98; applications, such as Microsoft Word or Excel; and documents created by applications, i.e., a word processing document created with Word. When shutting down a computer, the user is typically presented with a series of decisions, such as, whether to save any open documents. Shutdown may additionally trigger a series of dialogs, generated by applications being terminated. Dialogues may also be generated by the operating system itself before shutting down. As used herein the term “dialog” means a window presented on a monitor associated with the computer, to which the user must respond before shutdown can proceed. Dismissing dialogs is typically accomplished by pressing the RETURN key in a Macintosh environment, or by pressing the ENTER key in a Windows environment. To terminate an application means to “Quit” in Apple's Macintosh operating system and “Exit” in the Microsoft Windows environment. Other operating systems use different terminology to reference termination of an application. In the Macintosh environment, a document is “terminated” by “CLOSING” the document. The Windows environment effects “termination” of a document by “EXITING” the document. Shutting down the computer means deactivating the operating system of the computer. In the Macintosh environment this step also powers down the computer.

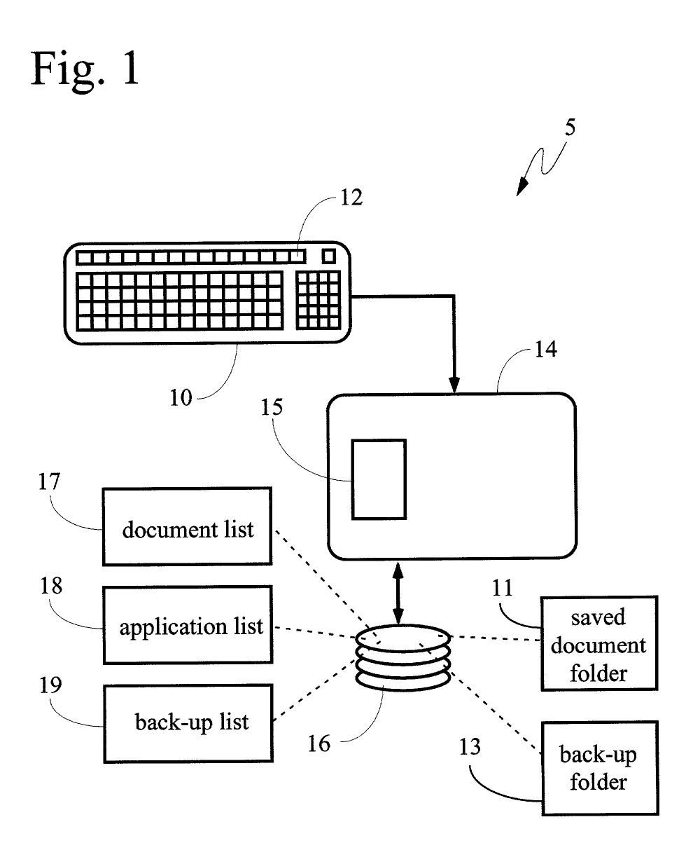

The system of the present invention is operative to shut down the computer upon activation of an emergency exit key without further input from the user. Referring to FIG. 1 of the drawings, there is shown generally at 5 a preferred embodiment of the invention. The system 5 is operative to terminate open applications and save preselected documents when shutting down a computer without further input from a user. System 5 comprises emergency exit key 12, document list 17, saved document folder 11, and a shutdown manager 15. Emergency exit key 12 is preferably a dedicated key added to the standard keyboard 10 of computer 14, and it initiates the shutting down of computer 14. Document list 17 comprises data that catalogs a list of documents preselected by the user. Document list 17 is preferably stored on hard drive 16 or other data storage device associated with computer 14. Hard drive 16 may be internal or external to computer 14, or reside on a network connected to computer 14. Saved document folder 11 is a location in a data storage means, such as a location on hard drive 16 or other storage device, preselected by the user for saving any documents that constitute a member of document list 17. Shutdown manager 15 is preferably a software program operating on computer 14. Shutdown manager 15 is operative to monitor the activation of the emergency exit key 12. Upon activation of emergency exit key 12, shutdown manager 15 saves to saved document folder 11 any open documents that constitute a member of document list 17. The shutdown manager 15 then terminates all open applications, and dismisses dialogs generated by any applications and dialogs generated by the operating system of computer 14.

Alternatively, emergency exit key 12 is a single preselected key such as F12 on a standard keyboard or a combination of preselected keys, such as control-shift-F12, on a standard keyboard of computer 14. As a further alternative, emergency exit key 12 comprises a switch or button located on the case or enclosure of computer 14.

Optionally, system 5 further comprises an application list 18 stored on hard drive 16. Application list 18 comprises data that catalogs a list of applications preselected by the user. Shutdown manager 15 is further operative to save, upon shutdown, any open documents created with applications that are a member of application list 18. In this manner, any open documents that were created with an application in application list 17 will be automatically saved to the location preselected by the user.

As another option, system 5 further comprises back-up list 19 and back-up folder 13. Back-up list 19 comprises data that catalogs a list of files preselected by the user to be automatically backed-up on shutdown. Back-up folder 13 comprises a folder location in data storage, such as hard drive 16 or other storage device, preselected by the user for saving any files that are a member of back-up list 19. Shutdown manager 15 is further operative to back-up folder 13 any files that constitute a member of back-up list 19.

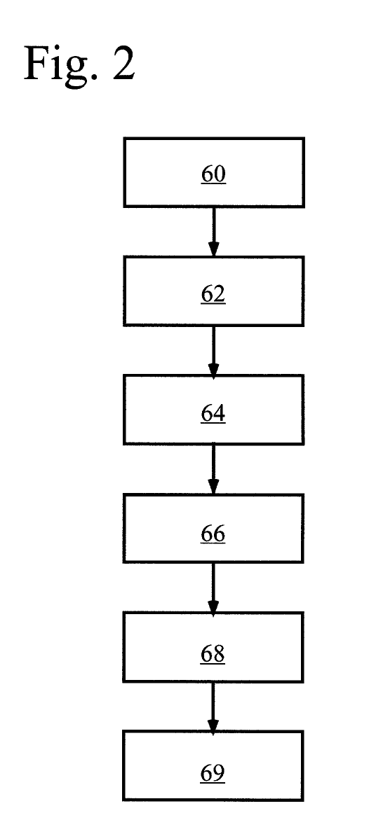

In FIG. 2 there is shown a second embodiment of the invention. The method for selecting preferences of system 5 described above comprises the steps of (a) selecting 60 a key combination to be used as the emergency exit key; (b) selecting 62 the documents for inclusion in a document list; and (c) selecting 64 a saved document folder appointed to store saved documents at a preselected location in data storage. The document list is indicated by reference numeral 17 in FIG. 1, while the saved document folder is indicated in FIG. 1 by reference numeral 11.

Optionally, the user may wish to save documents created by specific applications. To do so, the user selects 66 the applications for inclusion in the application list, shown at 18 in FIG. 1. As a further option, the user selects 68 those files appointed for inclusion in a back-up list and then selects 69 a back-up folder where the backed-up files will be stored in data storage. The back-up list is identified in FIG. 1 by reference numeral 19, while the back-up folder is identified by reference numeral 13.

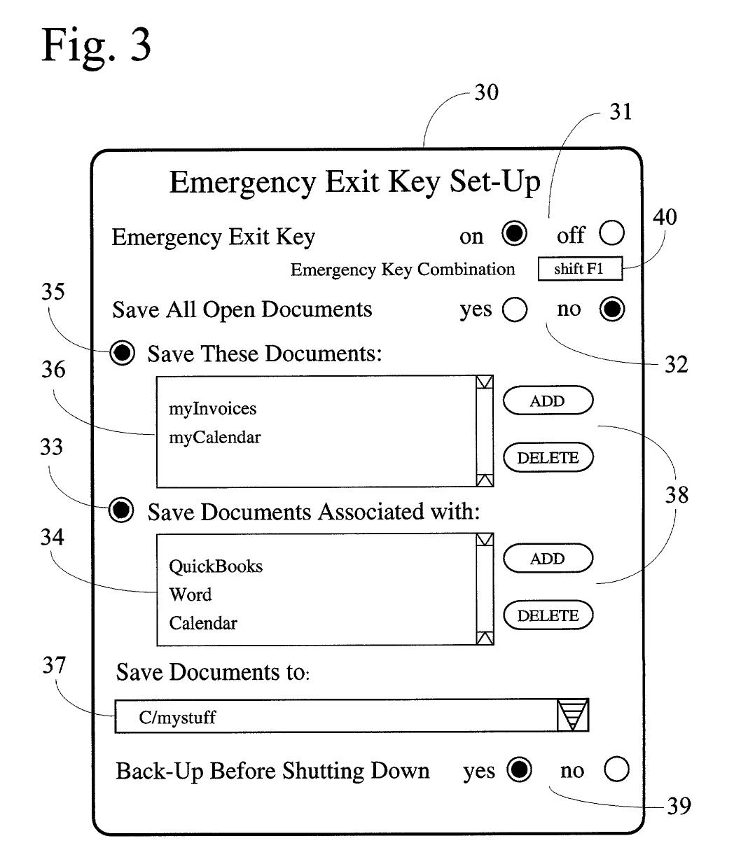

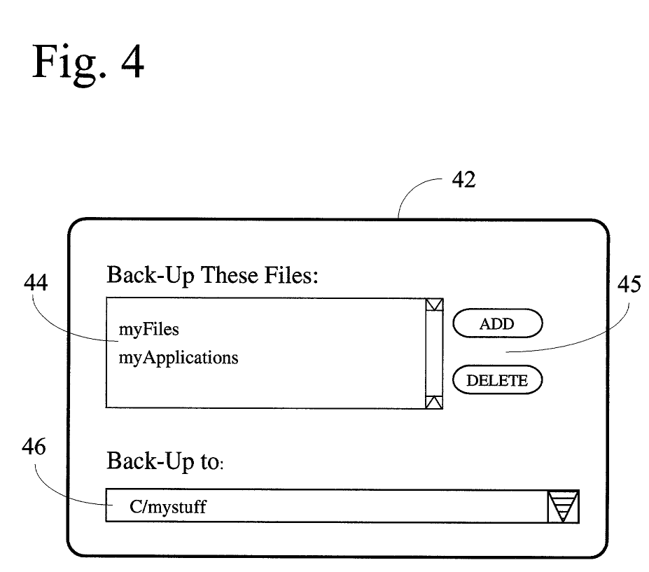

Referring to FIGS. 3 and 4 of the drawings, there are shown sample set up windows for saving files and backing up files, respectively. The user can preselect certain preferences for the system 5 of FIG. 1. Window 30 can be used when preselecting the emergency exit key set-up. The user activates the program selecting ON or OFF at 31. If the system does not have a dedicated key, the user selects the key or combination of keys by typing in the selection at 40. The user indicates at 32 whether all open documents are to be saved. Specific documents may be selected for saving on shutdown by indicating this option at 35 and inserting the preselected documents at 36. The documents listed at 36 constitute members of the document list 17, shown by FIG. 1. An election may be taken to save documents associated with specific applications, i.e., all MS Word documents. This is accomplished by indicating at 33 and inserting the preselected applications at 34. The documents listed at 34 constitute members of the application list 18, shown by FIG. 1. Addition and deletion of files to lists 36 and 34 are facilitated by ADD and DELETE buttons indicated at 38. The user, once preselecting documents to be saved, must select the location in data storage that the saved documents will be located. This selection is done in window 30 by typing in the location at 37. Lastly, the user selects whether the shutdown procedure is to include file back up. This selection is made at 39. Indicating YES automatically brings up window 42, shown in FIG. 3. The user indicates the preselected files to be backed-up upon shutdown at 44 and the location for the backed-up files at 46. Adding and deleting files to the back-up file list is facilitated by the ADD and DELETE buttons at 45. The files listed at 44 constitute members of the back-up list, designated in FIG. 1 by reference numeral 19.

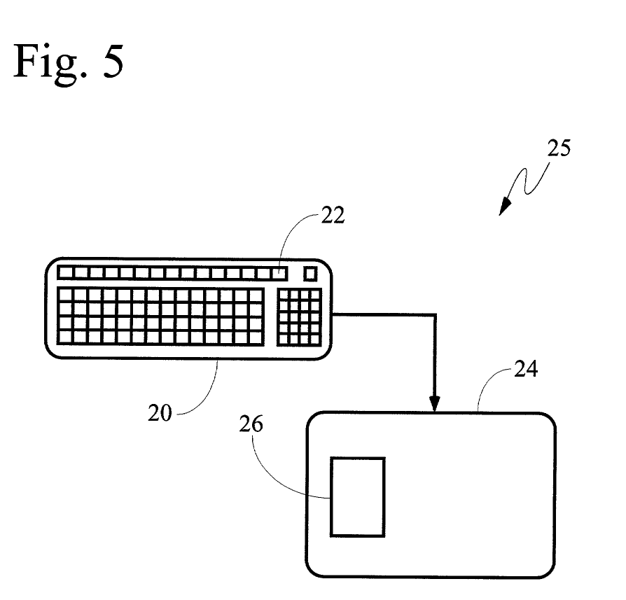

The fastest method for effecting shut down of a computer is by cutting off the power. If repeatedly used to effect shut down, this method can damage the computer's operating system or file directories. The present invention provides a method and means for achieving a very fast and controlled shutdown of the computer without damage to its operating system or file directories. With this embodiment, shown in FIG. 5, no documents are saved and no files are backed-up during shut down.

Referring to FIG. 5, there is shown, a system 25 comprising emergency exit key 22 for shutting down computer 24. System 25 further includes a shutdown manager 26 for terminating open documents and applications. The shutdown manager 26 additionally functions during shut down to dismiss (i) dialogs generated by applications, and (ii) dialogs generated by the operating system. Preferably, emergency exit key 22 comprises a dedicated key added to standard keyboard 20. Alternatively, emergency exit key 22 comprises a single preselected key, such as F12, on a standard keyboard, or a combination of preselected keys, such as control-shift-F12, on a standard keyboard associated with computer 24. As a further alternative, emergency exit key 22 can comprise a switch or button located on the case or enclosure of computer 24.

The invention further provides a method for shutting down a computer, which is initiated when the user pushes a preselected key or combination of keys for a preselected time, and proceeds rapidly and continuously to shut down the computer without further input from the user. As a first step of the method, any open preselected document is saved to a preselected storage location 51. Thereafter, all remaining open documents are terminated 53. Subsequently, the method is carried out by terminating all open applications 55, and dismissing all dialog windows 57. Finally, the method proceeds with shutdown 59 of the computer's operating system.

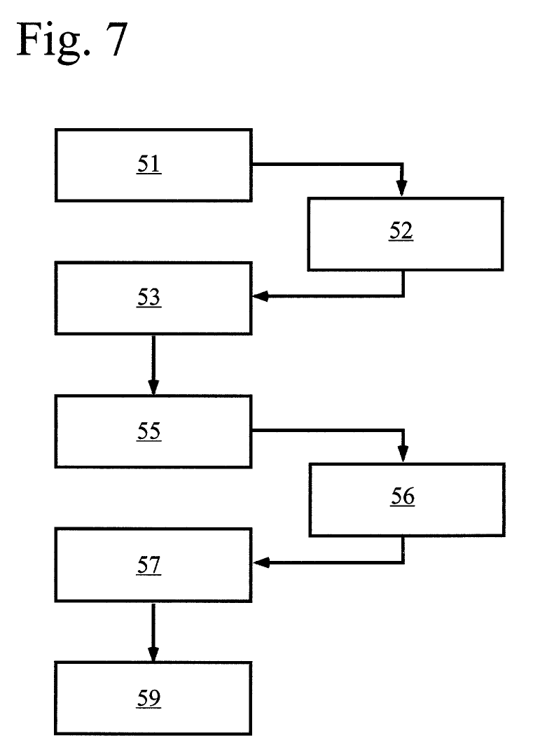

In FIG. 7 there is shown and optional embodiment in which open documents associated with a preselected application are saved selectively. That is to say, those open documents constituting members of a preselected application list are saved 52 prior to terminating open documents 53. Also shown in FIG. 7 is a further option in which preselected files are backed-up to a preselected storage location 56 prior to dismissing all dialog windows 57.

Having thus described the invention in rather full detail, it will be understood that such detail need not be strictly adhered to, but that additional changes and modifications may suggest themselves to one skilled in the art, all falling within the scope of the invention as defined by the subjoined claims.

What is claimed is:

1. A system for shutting down a computer having an operating system, open applications and documents, and being operative during shutdown to terminate the applications and save the documents without further input from a user, comprising:
a. an emergency exit key for shutting down said computer;
b. a document list stored in data storage of said computer, said document list comprising data listing said documents;
c. a saved document folder in said data storage;
d. a shutdown manager responsive to activation of said emergency exit key, for saving to said saved document folder any open documents that constitute a member of said document list,
whereby upon activation of said emergency exit key, said shutdown manager saves any open documents to said saved document folder that constitute a member of said document list, terminates open applications, and dismisses dialogs generated by said applications and dialogs generated by the operating system of said computer.

2. A system as recited by claim 1, further comprising an application list stored in said data storage and listing preselected applications, said shutdown manager being further operative to save to said saved document folder, upon shutdown, any open documents created with applications that constitute a member of said application list.

3. A system as recited by claim 1, further comprising:
a. a back-up list stored in said data storage and listing preselected files, said shutdown manager being further operative to back-up, upon shutdown, any files that constitute a member of said back-up list; and
b. a back-up folder in said data storage for storing said preselected files.

4. A system as recited by claim 1, wherein said emergency exit key is located on the keyboard of said computer.

5. A system as recited by claim 1, wherein said computer has a housing for containing said hardware and software, and said emergency exit key is located on said housing.

6. A system as recited by claim 1, wherein said emergency exit key comprises a combination of preselected keys on the keyboard of said computer.

7. A system for shutting down a computer having an operating system, open applications and documents, and being operative during shutdown to terminate the applications and save the documents without further input from a user, comprising:
a. an emergency exit key for shutting down said computer; and
b. a shutdown manager for terminating open applications and dismissing dialogs generated by said applications and dialogs generated by the operating system of said computer.

8. A method for selecting preferences of the system recited by claim 1, comprising the steps of:
a. selecting an emergency key combination;
b. selecting documents for inclusion in a document list; and
c. selecting a save document folder.

9. A method as recited by claim 8, further comprising the step of selecting applications for an application list.

10. A method as recited by claim 8, further comprising the steps of:
a. selecting files for inclusion in a back-up list; and
b. selecting a back-up folder.

11. A method for shutting down a computer having an operating system, open applications and documents, comprising the steps of:
a. depressing a preselected key of a keyboard associated with said computer;
b. saving any open preselected document to a preselected storage location;
c. terminating all open documents;
d. terminating all open applications;
e. dismissing all dialog windows; and
f. shutting down the operating system of said computer, said steps “a” through “f” being effected automatically, without further input from an operator of said computer.

12. A method as recited by claim 4, further comprising the step of saving any open document associated with an application that constitutes a member of a preselected application list, said saving step occurring prior to said terminating of all open documents.

13. A method as recited by claim 4, further comprising the step of backing-up preselected files to a preselected storage location, said backing-up step occurring prior to said shutting down of said operating system.
